(19) United States
(12) Patent Application Publication
(10) Pub. No.: US 2022/0002032 A1
(43) Pub. Date: Jan. 6, 2022

(54) WATER CONTAINER FOR CAMPING

(71) Applicant: Chan Suk Lee, Hanam-si (KR)

(72) Inventor: Chan Suk Lee, Hanam-si (KR)

(21) Appl. No.: 17/096,685

(22) Filed: Nov. 12, 2020

(30) Foreign Application Priority Data
Jul. 6, 2020 (KR) 10-2020-0083084

(51) Int. Cl. B65D 25/48; B65D 47/06; B65D 47/12; B65D 51/16

(52) U.S. Cl. CPC B65D 25/48; B65D 47/068; B65D 2547/066; B65D 51/1633; B65D 47/127

(57) ABSTRACT

Disclosed is a water container for camping. The water container for camping of the present invention comprises: a connector part which is coupled to a main body in which water is stored and provided as a discharge passage of the water stored in the main body; an opening/closing part which is coupled to the connector part and provided as an air passage while discharging the water flowing into the connector part by opening/closing one side portion of the connector; and a water inflow prevention part of which one side portion is floated by the water stored in the main body and the other side portion is connected to the connector part so as to prevent the water from flowing into a passage of air to be discharged through the connector part and the opening/closing part.

### CROSS-REFERENCE TO RELATED APPLICATIONS

This application claims the priority of Korean Patent Application No. 10-2020-0083084 filed on Jul. 6, 2020 in the Korean Intellectual Property Office, the disclosure of which is incorporated herein by reference.

### BACKGROUND OF THE INVENTION

### Field of the Invention

The present invention relates to a water container, and more particularly, to a water container for camping that can be used in outdoor places such as camping and is provided with a water passage and an air passage independently of each other so as to quickly discharge a large amount of water.

### Description of the Related Art

The domestic camping and leisure industry is entering a development stage such as unitization of camping facility types and service providers and development of related industries such as camping goods along with an increase in camping demand.

The types of camping sites have also been diversified, and based on camping facilities, there are general camping sites, auto camping sites, caravan (camping car) camping sites, etc., and depending on a location, there are a beach type, a lake (riverside) type, a mountain type, a valley type, a city type, a closed school type, etc.

Currently, the camping and leisure industry goes beyond merely camping-related facilities, and the development of the camping goods industry such as clothing, tents, cooking goods, protective equipment, and leisure goods has also been accelerated.

On the other hand, drinking water is indispensably required for camping, and there are water sources such as tap water in camping places, but most of water is contained and used in a water container.

When a water container including a conventional camping water container is provided in a nozzle type, the water container is not divided into a water discharge passage and an air discharge passage so that water is discharged through an air inlet path. As a result, there is a problem in that the water discharged through the air inlet path interferes with the inflow and circulation of air so that the water is not discharged well, and thus, an improvement measure is required.

The above-described technical configuration is a background technique for assisting the understanding of the present invention, and does not mean a conventional technology widely known in the art to which the present invention belongs.

### SUMMARY OF THE INVENTION

Therefore, an object of the present invention is to provide a water container for camping that can be used in outdoor places such as camping and is provided with a water passage and an air passage independently of each other so as to quickly discharge a large amount of water.

According to an aspect of the present invention, there is provided a water container comprising: a connector part which is coupled to a main body in which water is stored and provided as a discharge passage of the water stored in the main body; an opening/closing part which is coupled to the connector part and provided as an air passage while discharging the water flowing into the connector part by opening/closing one side portion of the connector; and a water inflow prevention part of which one side portion is floated by the water stored in the main body and the other side portion is connected to the connector part so as to prevent the water from flowing into a passage of air to be discharged through the connector part and the opening/closing part.

The connector part may comprise a connector body of which one side portion is coupled to the main body and the other side portion is coupled to the opening/closing part to transmit the water to the opening/closing part; a first coupling rod to which one side portion of the opening/closing part is coupled; and a second coupling rod which is provided so as to communicate with the first coupling rod and has one side portion of the water inflow prevention part connected thereto.

The water inflow prevention part may comprise a floating body floated inside the main body by buoyancy of water; and hose member of which one side portion is coupled to the floating body and the other side portion is coupled to the second coupling rod to supply the air flowing into the floating body to the second coupling rod or supply vice versa.

The opening/closing part may comprise an opening/closing base body which is detachably coupled to the connector body of the connector body; a coupling ring which is provided inside the opening/closing base body; an opening/closing body which is coupled to the coupling ring and moved together with the opening/closing base body to open and close an end portion of the connector body; and a connection rod which is provided in the opening/closing body and coupled to the first coupling rod to discharge the air supplied through the first coupling rod to the outside of the opening/closing body. The connector part may further comprise an O-ring provided in an area where an inner wall of the opening/closing base body is in contact with an outer wall of the connector body, and further comprise sealing members provided in an area where the opening/closing body is in contact with the connector body, an area where the connection rod is in contact with the first coupling rod, and an area where the base body is in contact with the connector body.

The water container may further comprise a cap part which is coupled to the opening/closing base body so as to communicate with the connection rod to separately discharge water and air to be supplied from the main body.

The main body may be provided with a first flat part and a second flat part to selectively erect the main body on the first flat part and the second flat part.

The connector and the opening/closing part maybe screwed, and the amount of water to be discharged may be controlled by adjusting the screwing or releasing of the connector and the opening/closing part.

According to the embodiments of the present invention, one side portion is floated by water stored in the main body and the other side portion is connected to the connector part to prevent water from flowing into the air passage by the water inflow prevention part that prevents the water from flowing into the passage of air to be discharged through the connector part and the opening/closing part, thereby discharging rapidly a large amount of water.

In addition, the main body can be used as a water bottle like an outdoor water purifier in addition to the basic use by the first and second flat parts provided on the main body.

Furthermore, according to the embodiments, when the second flat part is mounted and used on the mounting holder, it is possible to prevent leakage of the water by using water or closing the opening/closing part while the opening/closing part is opened.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a water container for camping according to an embodiment of the present invention;

FIG. 2 is an exploded perspective view of FIG. 1;

FIG. 3 is a cross-sectional view of main parts of FIG. 1;

FIG. 4 is a perspective view illustrating that a water inflow prevention part is coupled to a connector part illustrated in FIG. 1;

FIG. 5 is an enlarged view illustrating a connector part, an opening/closing part, and a cap part shown in FIG. 2;

FIG. 6 is a view illustrating a state in which the connector part is closed by the opening/closing part as an operational view of the embodiment; and

FIG. 7 is a view schematically illustrating that the opening/closing part and the cap part are moved to the left side so that an end portion of the connector part is opened to discharge the water.

### DETAILED DESCRIPTION OF THE PREFERRED EMBODIMENT

In order to fully understand the present invention, operational advantages of the present invention and objects achieved by implementing the present invention, the prevent invention will be described with reference to the accompanying drawings which illustrate preferred embodiments of the present invention and the contents illustrated in the accompanying drawings.

Hereinafter, preferred embodiments of the present invention will be described in detail with reference to the accompanying drawings. Like reference numerals illustrated in the respective drawings designate like members.

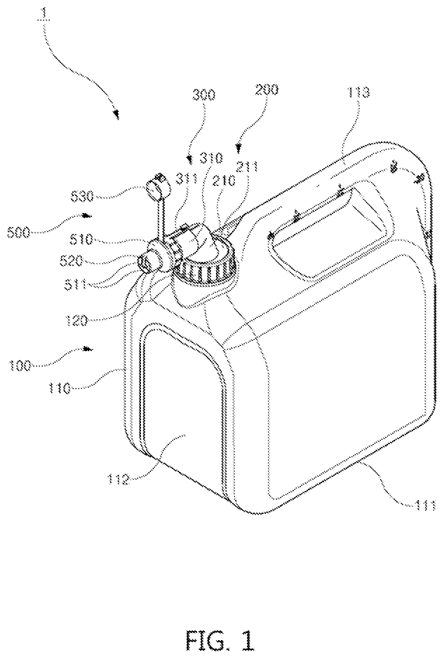

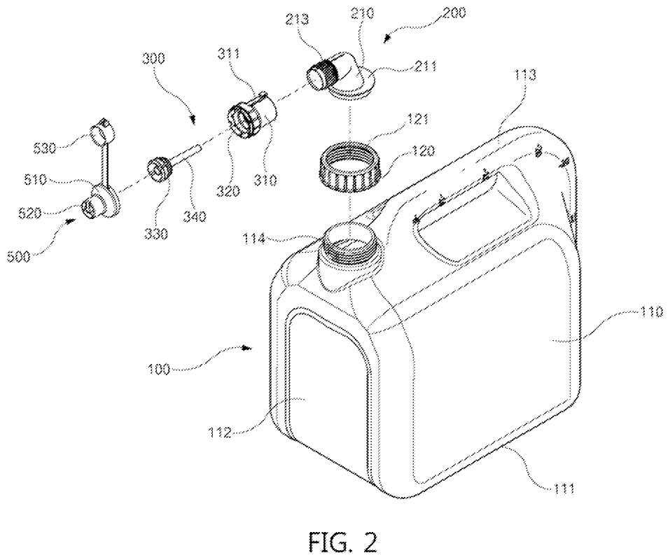

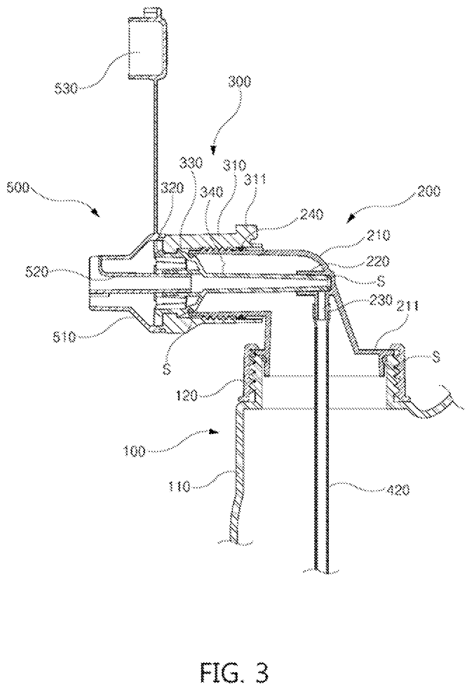

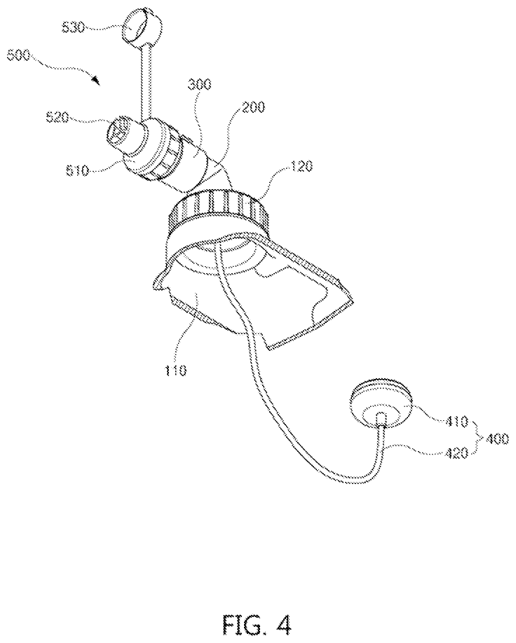

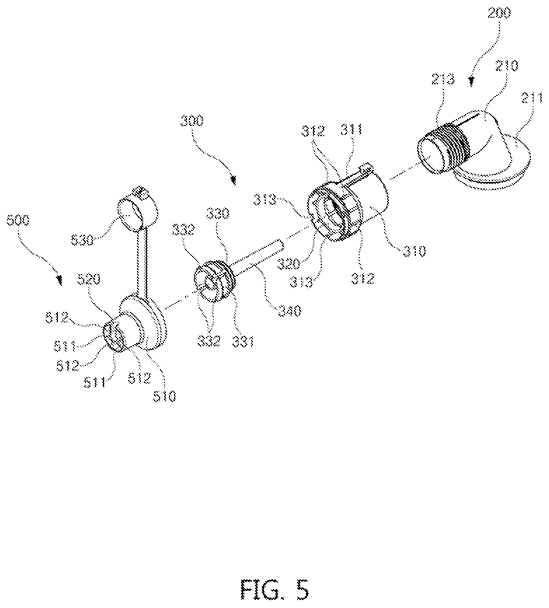

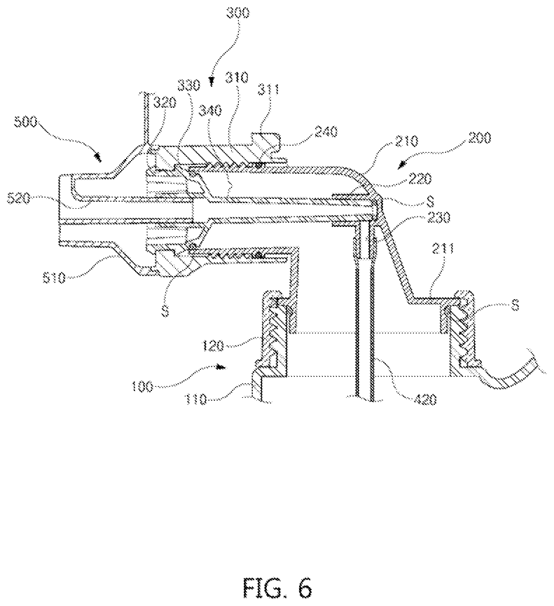

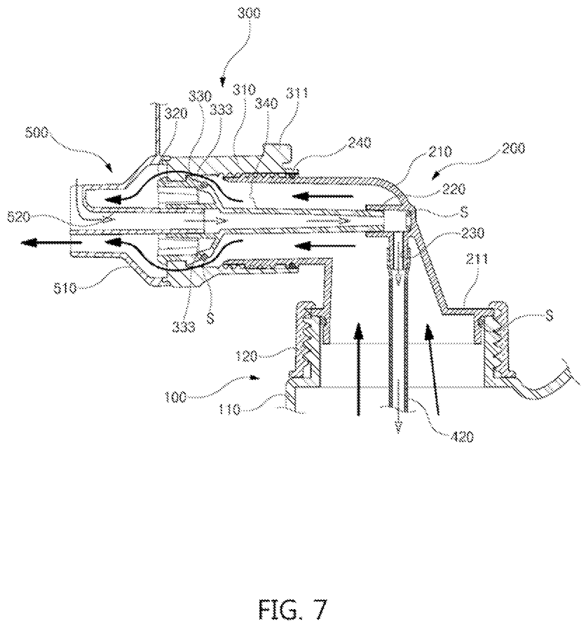

FIG. 1 is a diagram schematically illustrating a water container for camping according to an embodiment of the present invention, FIG. 2 is an exploded perspective view of FIG. 1, FIG. 3 is a cross-sectional view of main parts of FIG. 1, FIG. 4 is a perspective view illustrating that a water inflow prevention part is coupled to a connector part illustrated in FIG. 1, FIG. 5 is an enlarged view illustrating a connector part, an opening/closing part, and a cap part shown in FIG. 2, FIG. 6 is a view illustrating a state in which the connector part is closed by the opening/closing part as an operational view of the embodiment, and FIG. 7 is a view schematically illustrating that the opening/closing part and the cap part are moved to the left side so that an end portion of the connector part is opened to discharge the water.

As illustrated in these drawings, a water container 1 for camping according to the embodiment includes a main body 100 in which water is stored, a connector part 200 coupled to the main body 100 and provided as a discharge passage of the water stored in the main body 100, an opening/closing part 200 coupled to the connector part 200 and provided as an air passage while discharging the water flowing into the connector part 200 by opening/closing one side portion of the connector, a water inflow prevention part 400 of which one side portion is floated by the water stored in the main body 100 and the other side portion is connected to the connector part 200 to prevent the water from flowing into the passage of air to be discharged through the connector part 200 and the opening/closing part 300, and a cap part 500 coupled to the opening/closing part 300 to separately discharge the water and the air to be supplied form the main body 100.

The main body 100 includes a base body 110 and a body cap 120 coupled to the base body 110 as illustrated in FIG. 2.

Water may be stored in the interior of the base body 110 of the main body 100, and as illustrated in FIG. 2, a first flat part 111 may be provided on a front wall of the base body 110 and a second flat part 112 may be provided on a bottom portion of the base body 110. In the embodiment, the second flat part 112 is placed at the bottom (referring to FIG. 2) usually to be used for basic uses, such as transferring and storing water, and when the water is received in cooking goods or used for washing, the first flat part 111 is disposed at the bottom and supported with a mounting holder to be used as a water container like an outdoor water purifier.

In the embodiment, a grip 113 may be provided on the upper portion of the base body 110, and a cap thread 121 provided on the body cap 120 is coupled to a body thread 114 provided on the base body 110 so that the body cap 120 may be detachably coupled to the base body 110.

As illustrated in FIG. 3, the connector part 200 may be pressed and coupled to an upper portion of the base body 110 by the body cap 120.

In the embodiment, as illustrated in FIG. 3, the connector part 200 includes a connector body 210 of which a lower portion is coupled to the base body 110 in an area where the body thread 114 is provided, a first coupling rod 220 provided on one side portion inside the connector body 210 and coupled with a connection rod 340 of the opening/closing part 300 to provide an air moving passage, a second coupling rod 230 provided on the other side portion inside the connection body 210 and coupled with a hose member 420 of the water inflow prevention part 400 to provide an air moving passage, and an O-ring 240 provided in an area where the base body 310 of the opening/closing part 300 is in contact with the connector body 210 to prevent the leakage of the water.

The connector body 210 of the connector part 200, as illustrated in FIG. 3, may have an overall ‘¬’ shape, and as illustrated in FIG. 7, water and air may be separately moved in an independent structure from each other inside the connector body 210.

In the embodiment, as illustrated in FIG. 3, a connector flange 211 is provided on a lower side portion of the connector body 210, and the connector flange 211 is supported on the upper surface of the base body 110 and may be pressed and then fixed by the body cap 120 coupled to the base body 110.

In addition, in the embodiment, as illustrated in FIG. 3, a sealing member S is in contact with an end portion of the connector body 210, and when the opening/closing body 330 is coupled to the connector body 210, the sealing member S is pressed to prevent the water from being leaked into a gap between the opening/closing body 330 and the connector body 210. In the embodiment, the area of the connector body 210 in contact with the sealing member S may be provided with an oblique like, that is, so that an inclination increases from the inner side to the outer side of the connector body 210, as illustrated in FIG. 7. In the embodiment, as illustrated in FIG. 3, the sealing members S are provided in the area where the connection rod 340 is in contact with the first coupling rod 220 and even in the area where the base body 110 is in contact with the connector body 210, thereby to prevent the water from being leaked to the gap. In the embodiment, the sealing member S includes an O-ring.

Further, in the embodiment, on an outer wall of the connector body 210, as illustrated in FIG. 5, a connector thread 213 is provided, and the opening/closing base body 310 of the opening/closing part 300 may be screwed thereto. Accordingly, the opening/closing part 300 may be moved forward and backward on the opening/closing base body 310 by rotation to open and close the opened end portion of the connector body 210.

The first coupling rod 220 of the connector part 200 may be provided in parallel with the connection rod 340 of the opening/closing part 300 as illustrated in FIG. 3 to be provided as a fitting and coupling place of the connection rod 340. In the embodiment, the sealing member S may be provided inside the first coupling rod 220 as described above, and the sealing member S is pressed by the end portion of the connection rod 340 to prevent the water from flowing into the first coupling rod 220.

In the embodiment, the first coupling rod 220, the second coupling rod 230, the coupling rod 340, and the hose member 420 may be provided as an air moving passage, and air flowing into a floating body 410 disposed in the base body 110 may be discharged to the outside through the hose member 420, the second coupling rod 230, the first coupling rod 220, the connection rod 340, and the air passage 520, and external air may be supplied into the base body 110 in the reverse order described above.

The second coupling rod 230 of the connector part 200 may be provided in the connector body 210 vertically to the first coupling rod 220 as illustrated in FIG. 3 to be provided as a coupling place of the hose member 420.

The O-ring 240 of the connector part 200 is inserted into a groove provided in the area where the opening/closing base body 310 is in contact with the connector body 210, as illustrated in FIG. 3, to prevent the water from being leaked through the gap therebetween.

The opening/closing part 300 may be rotated by a user to open and close the opened end portion of the connector body 210, and may adjust the amount or flow rate of water to be discharged according to the degree of rotation.

In the embodiment, as illustrated in FIG. 3, the opening/closing part 300 includes an opening/closing base body 310 that is detachably coupled to the connector body 210, a coupling ring 320 that is provided inside the opening/closing base body 310, an opening/closing body 330 that is coupled to the coupling ring 320 and moved together with the opening/closing base body 310 to open and close the end portion of the connector body 210, and a connection rod 340 which is provided in the opening/closing body 330 and coupled to the first coupling rod 220 to discharge the air to be supplied through the first coupling rod 220 to the outside of the opening/closing body 330.

As illustrated in FIG. 3, the opening/closing base body 310 of the opening/closing part 300 is screwed to the connector thread 213 of the connector body 210 and is rotated along the connector thread 213 by the user to open and close the opened end portion of the connector body 210.

In the embodiment, when the opening/closing base body 310 is rotated a certain number of times, as illustrated in FIG. 7, the opening/closing part 300 and the cap part 500 are moved to the left side with reference to FIG. 7. As a result, the opening/closing body 330 blocking the opened end portion of the connector body 210 is spaced apart from the connector body 210 and the water stored in the base body 110 flows into the cap body 510 through a space between the end portion of the connector body 210 and the opening/closing body 330 to be discharged to the outside of the cap body 510.

In the embodiment, the outer wall of the opening/closing base body 310 is provided with a protrusion part 311 and a plurality of rotation guide protrusions 312 as illustrated in FIG. 5 to more smoothly rotate the opening/closing base body 310. In the embodiment, a cover 530 of the cap part 500 may be detachably fitted and coupled to the protrusion part 311.

In addition, in the embodiment, in the front of the opening/closing base body 310, as illustrated in FIG. 5, a plurality of cutout holes 313 are provided to be spaced apart from each other, and a plurality of protrusions provided in the cap body 510 are fitted and coupled thereto.

The coupling ring 320 of the opening/closing part 300 is provided in a ring shape inside the opening/closing base body 310 as illustrated in FIG. 5, and is coupled to the opening/closing body 330 as illustrated in FIG. 3 to fix the opening/closing body 330 and to move the opening/closing body 330 together with the opening/closing base body 310.

The opening/closing body 330 of the opening/closing part 300 may have a substantially semicircular shape, as illustrated in FIG. 3, and an air passage 520 of the cap part 500 may be coupled therein, and the air passage 520 may communicate with the connection rod 340.

In the embodiment, the coupling ring 320 may be fitted and coupled to the coupling groove 331 of the opening/closing body 330.

In addition, in the embodiment, in the opening/closing body 330, as illustrated in FIG. 5, a plurality of cutout parts 332 are provided to be spaced apart from each other, so that the opening/closing body 330 and the coupling ring 320 may be easily coupled to each other.

Further, in the embodiment, as illustrated in FIG. 7, the sealing member S may be coupled to a sealing member coupling groove 333 of the opening/closing body 330.

As illustrated in FIG. 3, the connection rod 340 of the opening/closing part 300 may be provided as an air moving passage by providing one side portion coupled to the first coupling rod 220 and the other side portion provided on the opening/closing body 330.

The water inflow prevention part 400 has one side portion connected to the connector part 200 and the other portion floated by buoyancy in the base body 110 to prevent water from flowing into the air moving passage.

In the embodiment, the water inflow prevention part 400, as illustrated in FIG. 4, includes a floating body 410, and a hose member 420 of which one side portion is coupled to the floating body 410 and the other side portion is coupled to the second coupling rod 230 illustrated in FIG. 3.

The floating body 410 of the water inflow prevention part 400 is filled with a floating material, for example, air, etc., so as to be floated inside the base body 110 by buoyancy.

In the embodiment, one side portion of the hose member 420 connected to the floating body 410 is connected to the floating body 410 and floats above the water surface inside the base body 110 so as to prevent the water from flowing into the hose member 420. As a result, it is possible to prevent a splashing phenomenon in which the flow rate and amount of water are remarkably lowered due to a phenomenon in which the water flows back into the air moving passage including the hose member 420.

In the embodiment, the floating body 410 is provided with a hole communicating with the hose member 420 so that air may be supplied into the base body 110 through the floating body 410, and on the contrary, the internal air of the base body 110 may be discharged to the outside through the floating body 410 and the hose member 420.

As illustrated in FIG. 3, one side portion of the cap part 500 is coupled to the opening/closing base body 310 and the other side portion of the cap part 500 is coupled to the opening/closing body 330, so that water and air may be separately discharged into independent areas from each other.

In the embodiment, as illustrated in FIG. 3, the cap part 500 includes a cap body 510 which is coupled to the opening/closing base body 310 to discharge water, an air passage 520 which is coupled to the opening/closing body 330 so as to communicate with the connection rod 340 to be provided to the air moving passage, and a cover 530 which is connected to the cap body 510 by a connection member to be detachably coupled to the cap body 510.

In the cap body 510 of the cap part 500, as illustrated in FIG. 5, a plurality of partition walls 511 are provided, and water stored in the base body 110 may be discharged through a plurality of discharge holes 512 partitioned by the plurality of partition walls 511.

A front end portion of the air passage 520 of the cap part 500 is provided to be cut, as illustrated in FIG. 3, so that the movement of air may be made more smoothly.

In the embodiment, one end portion of the air passage 520 may be coupled to the opening/closing body 330, as illustrated in FIG. 3, and the air flowing into or out of the air passage 520 may be supplied to the connection rod 340 through the inside of the opening/closing body 330.

As described above, according to the embodiments, one side portion is floated by water stored in the main body and the other side portion is connected to the connector part so as to prevent water from flowing into the air passage by the water inflow prevention part that prevents the water from flowing into the passage of air to be discharged through the connector part and the opening/closing part, thereby discharging rapidly a large amount of water.

In addition, the main body can be used as a water bottle like an outdoor water purifier in addition to the basic uses by the first and second flat parts provided on the main body.

Furthermore, according to the embodiments, when the second flat part is mounted and used on the mounting holder, it is possible to prevent leakage of the water by using water or closing the opening/closing part while the opening/closing part is opened.

As described above, the present invention is not limited to the embodiments described herein, and it will be apparent to those skilled in the art that various changes and modifications maybe made without departing from the spirit and the scope of the present invention. Therefore, it will be understood that these changed examples or modified examples are included in the appended claims of the present invention.

What is claimed is:

1. A water container for camping comprising:
a connector part which is coupled to a main body in which water is stored and provided as a discharge passage of the water stored in the main body;
an opening/closing part which is coupled to the connector part and provided as an air passage while discharging the water flowing into the connector part by opening/closing one side portion of the connector; and
a water inflow prevention part of which one side portion is floated by the water stored in the main body and the other side portion is connected to the connector part so as to prevent the water from flowing into a passage of air to be discharged through the connector part and the opening/closing part.

2. The water container for camping of claim 1, wherein the connector part comprises
a connector body of which one side portion is coupled to the main body and the other side portion is coupled to the opening/closing part to transmit the water to the opening/closing part;
a first coupling rod to which one side portion of the opening/closing part is coupled; and
a second coupling rod which is provided so as to communicate with the first coupling rod and has one side portion of the water inflow prevention part connected thereto.

3. The water container for camping of claim 2, wherein the water inflow prevention part comprises
a floating body floated inside the main body by buoyancy of water; and
a hose member of which one side portion is coupled to the floating body and the other side portion is coupled to the second coupling rod to supply the air flowing into the floating body to the second coupling rod or supply vice versa.

4. The water container for camping of claim 2, wherein the opening/closing part comprises
an opening/closing base body which is detachably coupled to the connector body of the connector body;
a coupling ring which is provided inside the opening/closing base body;
an opening/closing body which is coupled to the coupling ring and moved together with the opening/closing base body to open and close an end portion of the connector body; and
a connection rod which is provided in the opening/closing body and coupled to the first coupling rod to discharge the air supplied through the first coupling rod to the outside of the opening/closing body.

5. The water container for camping of claim 4, wherein the connector part further comprises an O-ring provided in an area where an inner wall of the opening/closing base body is in contact with an outer wall of the connector body, and
further comprises sealing members provided in an area where the opening/closing body is in contact with the connector body, an area where the connection rod is in contact with the first coupling rod, and an area where the base body is in contact with the connector body.

6. The water container for camping of claim 4, further comprising:
a cap part which is coupled to the opening/closing base body so as to communicate with the connection rod to separately discharge water and air to be supplied from the main body.

7. The water container for camping of claim 1, wherein the main body is provided with a first flat part and a second flat part to selectively erect the main body on the first flat part and the second flat part.

8. The water container for camping of claim 1, wherein the connector and the opening/closing part are screwed, and
the amount of water to be discharged is controlled by adjusting the screwing or releasing of the connector and the opening/closing part.
